(19) United States
(12) Patent Application Publication
(10) Pub. No.: US 2026/0359453 A1
(43) Pub. Date: Nov. 12, 2026

(54) Context-Aware Data Security-In-Transit Encryption Algorithm For Cloud Infrastructure

(71) Applicant: Oracle International Corporation, Redwood Shores, CA (US)

(72) Inventors: Senthil Kumar Nandagopalan, Malvern, PA (US); Johnson Manuel-Devadoss, San Antonio, TX (US)

(73) Assignee: Oracle International Corporation, Redwood Shores, CA (US)

(21) Appl. No.: 19/205,764

(22) Filed: May 12, 2025

(51) Int. Cl. G06F 21/60; H04L 9/40; H04L 43/0876

(52) U.S. Cl. CPC G06F 21/602; G06F 21/606; H04L 43/0876; H04L 63/1416

(57) ABSTRACT

At least one non-transitory computer-readable media storing instruction that, when executed by one or more hardware processors, causes performance of operations, is disclosed. The operations include obtaining a first set of data for transmission across a computing environment using a transmission process. The computing environment comprising a first set of computing resources. The operations include determining a first set of encryption requirements for the first set of data after obtaining the first set of data and in real-time during the transmission process. Based on the first set of encryption requirements for the first set of data, these operations also include selecting a first encryption strategy from various encryption strategies in real-time for encrypting the first set of data, encrypting the first set of data using the first encryption strategy to generate an encrypted first set of data, and transmitting the encrypted first set of data across the computing environment.

### TECHNICAL FIELD

The present disclosure relates to encryption data for computing environments. In particular, the present disclosure relates to using a multi-layered, context-aware encryption model that leverages a combination of block-based encryption, dynamic key rotation, and machine learning-based anomaly detection to provide both security and efficiency for sensitive data for movement through cloud networks and computer networks.

### BACKGROUND

Cloud and computer infrastructures are integral to business operations. The cloud infrastructure allows data to be distributed across cloud and multi-cloud environments.

As cloud and computer infrastructures become more integral to business operations, the secure transmission of sensitive data across distributed and multi-cloud environments and computer environments has become a critical concern. Traditional encryption methods, while effective in certain scenarios, often fail to provide the right balance between security and performance, particularly in the dynamic and high-speed nature of modern cloud and computer networks. These conventional solutions struggle to address the growing complexity of cloud-native applications that require low-latency communication alongside robust data protection. Moreover, the evolving landscape of cybersecurity threats—including advanced persistent threats, man-in-the-middle attacks, Distributed Denial-of-Service (DDoS) attacks, and the looming risk posed by quantum computing—has rendered many existing encryption techniques inadequate. Traditional encryption solutions lack adaptability to changing network conditions, varying data sensitivity, and evolving threats, making them less suitable for modern cloud and computer environments.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a computing environment in accordance with one or more embodiments;

FIG. 1B illustrates a strategic encryption platform (SEP) and data repository in accordance with one or more embodiments;

FIG. 2 illustrates an example set of operations performed by the SEP in accordance with one or more embodiments;

FIG. 3 illustrates a detailed example of a mapping between different encryption requirements and the different encryption strategies; and

FIG. 4 illustrates a computer system in accordance with some embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. SYSTEM ARCHITECTURE
3. FLOWCHARTS IMPLEMENTING OPERATIONS FOR ENCRYPTING DATA FOR A COMPUTING ENVIRONMENT(S)
4. EXAMPLE EMBODIMENT
5. COMPUTER NETWORKS AND CLOUD NETWORKS
6. HARDWARE OVERVIEW
7. MISCELLANEOUS; EXTENSIONS

### 1. General Overview

One or more embodiments select encryption strategies at run time for transmission of a dataset across a computing environment. The system may select the encryption strategy at any level of granularity. For example, the system may select a first encryption strategy for the transmission of a first dataset and a different, second encryption strategy for the subsequent transmission of a second dataset. The system may select a first encryption strategy for the transmission of a first set of packets and a different, second encryption strategy for the subsequent transmission of a second set of packets.

One or more embodiments select the encryption strategy for encrypting a dataset at run time based on the characteristics of the dataset that is to be transmitted. The characteristics may include, for example, a priority level, a confidentiality level, a sensitivity level, a compliance requirement, a Quality of Service (QoS) requirement for the dataset, an encryption requirement for the dataset, and an amount of data to be transmitted. The characteristics may be determined via an analysis of the dataset and/or metadata received with the dataset.

One or more embodiments select the encryption strategy for encrypting a dataset at run time based on the characteristics of a computing environment to be traversed by the dataset during the transmission of the dataset. The system identifies a path to be traversed and/or characteristics of the path to be traversed by the dataset. In an example, the system determines that the dataset will be traversing a public network. Alternatively or additionally, the system determines that the dataset will be traversing through network infrastructure components located within a particular country. Furthermore, the system may determine a level of security associated the computing environment to be traversed by the dataset. Other characteristics of the computing environment include, but are not limited to, network latency, up-time, and a composition of the computing environment. The system may select the encryption strategy based on the characteristics of each of a set of networks (e.g., Autonomous Systems) to be traversed by the dataset. The system may select the encryption strategy based on a set of historical, current, or predicted types of attack implemented within the computing environment.

One or more embodiments described in this Specification and/or recited in the claims might not be included in this General Overview section.

### 2. System Architecture

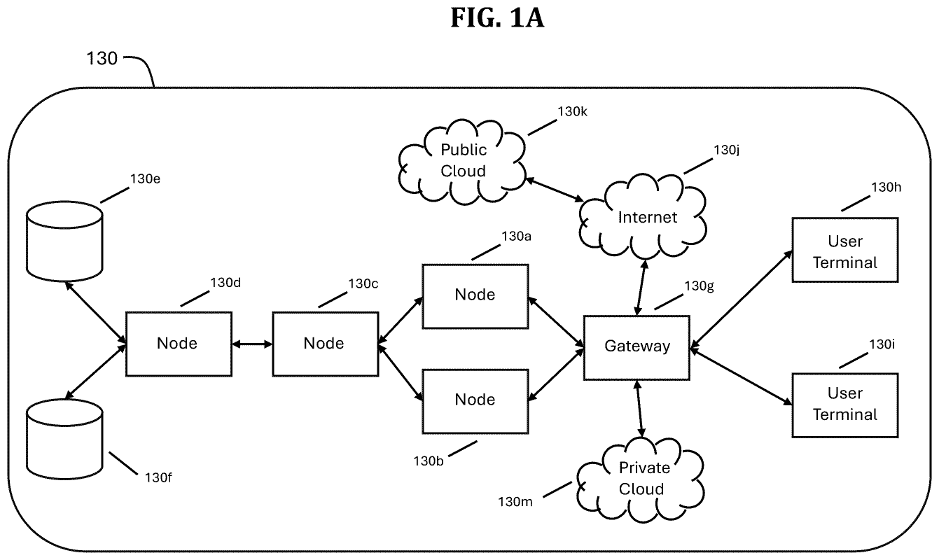

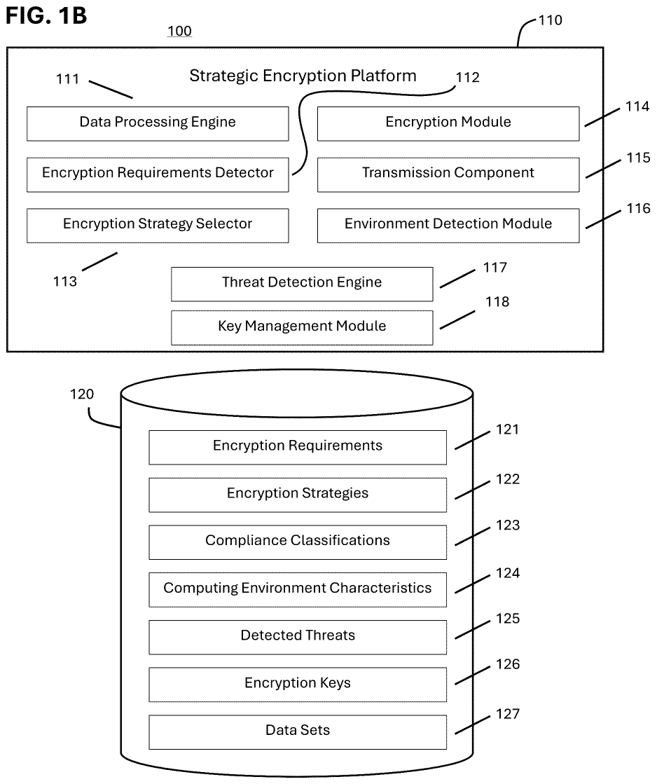

FIG. 1A illustrates an over simplified example of a computing environment 130 in accordance with one or more embodiments. FIG. 1B illustrates a system 100 that may be implemented by a component or across multiple components within the computing environment 130. The computing environment 130 and the system 100 may include more or fewer components than the components illustrated in FIGS. 1A and 1B, respectively. The components illustrated in FIGS. 1A and 1B may be local to or remote from each other. The components illustrated in FIGS. 1A and 1B may be implemented in software and/or hardware. Each component may be distributed over multiple applications and/or machines. Multiple components may be combined into one application and/or machine. Operations described with respect to one component may instead be performed by another component.

In one or more embodiments, the computing environment 130 of FIG. 1A includes a set of compute nodes. One or more of the components 130a-130f may include a compute node. A compute node is a resource on which applications are executed. Examples of compute nodes include a physical machine, a virtual machine (VM), and a data storage device. Each compute node has a specific set of configurations and various configurations can be applied across compute nodes. A compute node configuration may include an operating system (OS). Examples of OSs include Unix, Linux, and Windows. A virtual machine is a digital version of a physical computer. Virtual machine software is executed on a host hardware device that includes a hardware processor and memory. Multiple virtual machines may execute on the same host hardware device. Although multiple virtual machines execute on the same host hardware device, the virtual machines execute operations independently of each other. Virtual machine software executes programs and operating systems, stores data, connects to networks, and performs other computing functions.

In one or more embodiments, the computing environment 130 is a cloud-based computing environment(s) or computing network environment(s). For example, any of the components 130a-130g may be hosted by one or more devices, such as servers or databases. The devices, such as servers or databases, may host one or more additional computing environments. One computing environment may be accessible by one tenant, and the other computing environment, sharing at least a portion of the same hardware devices, is accessible by another tenant. A tenant is a corporation, organization, enterprise, or other entity that accesses a shared computing resource, such as components 130a-130g or applications executing on components 130a-130g. In some embodiments, the computing environment 130 may include one or more cloud environments and/or computing network environments. In other embodiments, the computing environment 130 may include a public, private, or hybrid and sovereign cloud (High-Compliance/Gov) as well as edge devices. The computing environment 130 may include a public cloud 130k accessible through the internet 130j from the gateway 130g. The computing environment 130 may additionally include a private cloud 130m accessible through the gateway 130g. In another embodiment, a node is a basic unit of computation in the computing environment 130. For example, a node can be a virtual machine or server that provides computational storage or network resources. The private cloud 130m and the public cloud 130k can be represented by groups of such nodes.

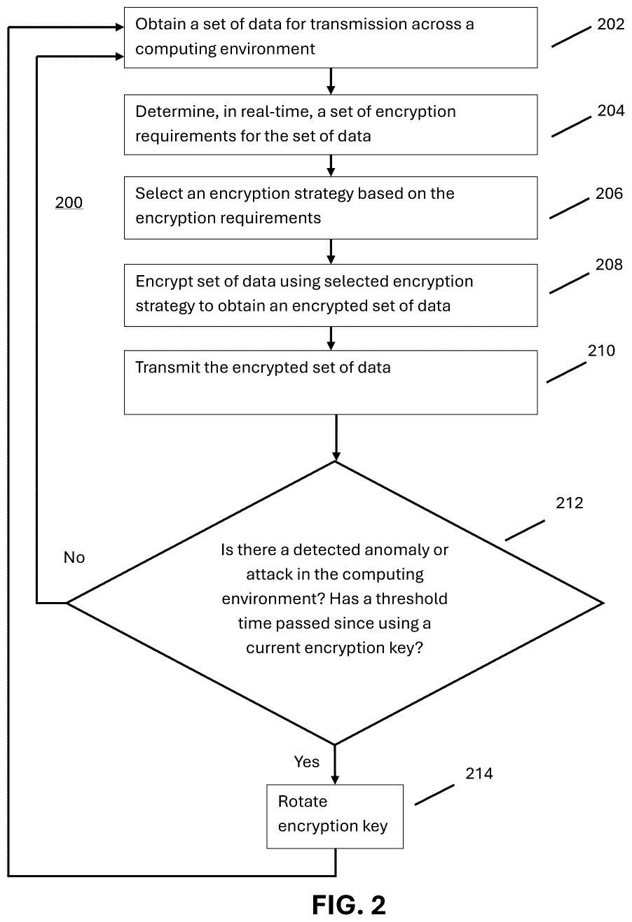

As noted above, computing environment 130 may implement system 100. System 100 may be distributed across one or more of components 130a-130g within computing environment 130. In an embodiment, system 100 includes a strategic encryption platform (SEP) 110, as illustrated in FIG. 1B. In one or more embodiments, the SEP platform 110 refers to hardware and/or software configured to perform operations described herein for determining an encryption strategy for encrypting a set of data, encrypting the set of data based on the encryption strategy, and transmitting the encrypted set of data across the computing environment 130 using machine learning to implement a security policy in the security environment. Examples of operations for applying machine learning to resources in a computing environment to implement data security standards in the computing environment 130 are described below with reference to FIG. 2.

The SEP 110 allows security features, for example, encryption, access control, and compliance, to be deployed and maintained in a computing environment 130, such as a cloud-based computing environment, a distributed computing environment, or a grid computing environment. Implementing security features in the computing environment 130 includes giving an entity-such as an individual or an enterprise-access to physical and software resources in the computing environment 130. For example, a user belonging to a particular entity may connect from a user terminal 130h or 130i to cloud-based resources and/or computer network resources of the computing environment 130 to execute applications in the computing environment 130 and transfer data between components of the computing environment 130 and the user terminal 130h or 130i. In an embodiment, a user terminal is the means by which a user interacts with a computer or software application, allowing them to control it and receive feedback. For example, the user terminals 130h and 130i may represent workstations.

In an embodiment, the SEP platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, networking equipment, a router, a switch, a controller, an access point, an edge device, and/or a client device.

In an embodiment, system 100 further includes a data repository 120. In one or more embodiments, the data repository 120 is any type of storage unit and/or device (e.g., a file system, database, collection of tables, or any other storage mechanism) for storing data. Furthermore, the data repository 120 may include multiple different storage units and/or devices. The multiple different storage units and/or devices may or might not be of the same type or located at the same physical site. Furthermore, the data repository 120 may be implemented or may execute on the same computing system as the SEP 110. Additionally, or alternatively, the data repository 120 may be implemented or executed on a computing system separate from the SEP 110. The data repository 120 may be communicatively coupled to the SEP 110 via a direct connection or via a network.

Information describing the data stored in the data repository 120 may be implemented across any of the components within the system 100. However, this information is illustrated within the data repository 120 for purposes of clarity and explanation.

The data repository 120 includes encryption requirements 121, encryption strategies 122, compliance classifications 123, computing environment characteristics 124, detected threats 125, encryption keys 126, and datasets 127. The encryption requirements 121, in an embodiment, are determined from the data to be encrypted and/or transmitted across the computing environment and may be stored in the data repository 120. The data repository 120 may also store encryption strategies 122. The encryption strategies 122 may be selected from the data repository 120 to encrypt data to be sent across or stored in the computing environment 130. For example, the encryption requirements associated with a set of data may include a compliance-based classification, and thus, based on the compliance-based classification for the set of data, an appropriate encryption strategy may be selected from the encryption strategies 122 for encrypting the set of data. The encryption strategies 122 that are available for use are stored in the data repository 120. In an embodiment, encryption strategies 122 stored in the data repository 120 may include, but are not limited to, types of encryption (e.g., symmetric encryption, asymmetric encryption, hashing, and/or hybrid encryption), encryption strengths or cipher strengths (i.e., the bit level to do the encryption at) (e.g., AES-128 vs. AES-256-bit encryption), and layering two or more encryption ciphers and/or cipher strengths. For example, types of strong ciphers may include Advanced Encryption Standard (AES), RSA with 2048-bit or larger keys, Elliptic Curve Cryptography (ECC), and Stream Encryption (ChaCha20). For instance, quantum-resistant layer (e.g., Lattice-Based Cryptography NTRU) may be selected from the encryption strategies 122 in response to detecting an AI-based attack. Types of moderate ciphers that are not as secure as strong ciphers may include, for example, triple DES (3DES) and RSA with 1024-bit keys. Examples of broken ciphers that are insecure may include Data Encryption Standard (DES) having a key size of 56 bits, RC4, or MD5/SHA-1. Additionally, the data repository 120 stores compliance-based classifications 123. For example, the compliance-based classifications stored in the data repository 120 may include levels of security for cloud-based defense workloads (e.g., Department of Defense (DoD) impact level 5 (IL5) or impact level 6 (IL6)), levels of security for Federal Risk and Authorization Management Programs (FedRAMP) (e.g., a low level of security is used for public websites; a moderate level of security is used for internal agency systems; and a high level of security is used for law enforcement, healthcare, or financial data), levels of security for General Data Protection Regulations (GDPR), and levels of security for Payment Card Industry Data Security Standards (PCI DSS). Also, the data repository 120 stores computing environment characteristics 124. Computing environment characteristics include qualities, traits, or features of the computing environment with respect to transmitting data securely within the computing environment 130. For example, the computing environment characteristics 124 may include the type or number of computer networks and the type or number of cloud-based computing networks within the computing environment 130. Encryption strategies can be determined based on the computing environment characteristics. Types of cloud networks can be stored as computing environment characteristics 124. For example, an encryption strategy for a computing environment characteristic, that includes both a private cloud and a public cloud network may be different from an encryption strategy for a computing environment characteristic that includes just a private cloud network. In other examples, a computing environment characteristic may include latency thresholds for applying to the computing environment 130. For example, encryption strategies can be determined based on current network latency conditions as compared to stored latency thresholds stored in the computing environment characteristics 124. The data repository 120 may also store detected threats 125 pertaining to the security of data within the computing environment 130. Encryption strategies may be adjusted or determined based on the detected threats 125 found in the computing environment 130. For example, a detected threat 125 that includes an AI-based attack on the computing environment 130 may cause the data to be encrypted with a quantum-resistant encryption layer. The data repository 120 may also store encryption keys 126. The encryption keys 126 may be used for securely encrypting and decrypting the data transmitted across the network. For example, symmetric keys, asymmetric keys, and session keys may be stored as encryption keys 126 within the data repository 120. Additionally, datasets 127 are stored in the data repository 120. The datasets 127 include data packets to be transmitted throughout the computing environment 130.

Referring to FIG. 1B, the SEP 110 includes a data preprocessing engine 111, an encryption requirements detector 112, an encryption strategy selector 113, an encryption module 114, a transmission component 115, an environment detection module 116, a threat detection engine 117, and a key management module 118.

The data preprocessing engine 111, in an embodiment, includes hardware and/or software components for obtaining data for transmission across the computing environment 130. The data preprocessing engine 111 then uses the encryption requirements detector 112 to read the data to obtain the encryption requirements associated with that data. For example, the encryption requirements detector 112 may detect from a packet of data that the data pertains to confidential health care data protected by HIPAA or classified government data protected by FedRAMP.

The encryption strategy selector 113 is used to select an encryption strategy from a plurality of encryption strategies 122 to choose and apply the most appropriate encryption method for protecting data—automatically, intelligently, and securely. In an embodiment, the encryption strategy selector 113 may be a component or tool that helps automatically or manually choose the best encryption method for a given situation based on various factors, such as the type of data, the sensitivity level of the data, the characteristics of the computing environment, the compliance requirements of the data, and the deployment environment (i.e., cloud, on-premises, or hybrid). For example, the encryption strategy selector 113 may select a high-level encryption strategy, for example ChaCha20, to apply a high level of security for streaming data that has been detected as confidential health care data protected by HIPAA or classified government data protected by FedRAMP. In some embodiments, the encryption strategy selector 113 may be implemented on a cloud storage platform within the computing environment 130 to apply AES-256 to sensitive data at rest, use TLS (with ECC) for secure data transfers, automatically rotate and manage encryption keys, and apply client-side encryption for highly sensitive customer data. In an embodiment, the encryption strategy selector 113 may select a quantum-resistant layer (e.g., Lattice-Based Cryptography NTRU) from the encryption strategies 122.

The SEP 110 may also include an encryption module 114. In an embodiment, the encryption module 114 is software code, a hardware element, or a combination thereof for implementing particular functionality. The encryption module 114 may encrypt and decrypt data. For example, the encryption module 114 converts readable data into an unreadable format using an algorithm or cipher, so authorized parties can read the encrypted data.

The transmission component 115 may be hardware, software, or a combination thereof involved in the movement of data from one place to another, whether it is between computers, servers, networks, devices, or components within the computing environment 130. The transmission component 115 may transmit encrypted data from any device etc., in the computing environment 130. More specifically, after selecting an encryption strategy to use for a set of data, the transmission component 115 may transmit the data with the selected encryption strategy. For example, after selecting ChaCha20 as the encryption strategy for a set of data, the transmission component 115 may transmit the set of data using a ChaCha20 encryption cipher between two or more devices in the computing environment 130.

The SEP 110 may also include an environment detection module 116. In an embodiment, the environment detection module 116 is software code, a hardware element, or a combination thereof for implementing a particular functionality. Here, the environment detection module 116 may detect computing environments or networks through which data is to be transmitted. For example, the environment detection module 116 may detect computing environment 130 and the path starting at user terminal 130h, to gateway 130g, to node 130a, to node 130c, to node 130d, and to database 130e, that the data is transmitted through. The environment detection module 116 may also detect multiple paths on which the data may or may not travel. The environment detection module 116 detects the characteristics of the detected computing environments and/or networks.

The threat detection engine 117 may monitor threats to the computing environment 130 by implementing an intrusion detection system (IDS), security information and event management (SIEM) systems, and firewalls, leveraging techniques like real-time traffic analysis, user behavior analysis, and vulnerability testing. This proactive approach to monitoring for threats, combined with regular security audits, helps identify and address potential vulnerabilities before they are exploited. The threat detection engine 117 may implement AI to detect anomalies or malicious activity within the computing environment 130. The threat detection engine 117 can monitor network traffic for indicators of compromise (IoCs) or malicious activities, like malware or ransomware. The threat detection engine 117 may regularly review and adjust monitoring strategies to accommodate new objectives, tools, and baseline metrics. The threat detection engine 117 may stay up to date with the latest threats and security best practices. The threat detection engine 117 may employ user behavior analytics (UBA) to analyze user behavior to identify lateral movements, compromised credentials, and risky behaviors that might indicate a threat. The threat detection engine 117 may leverage firewalls for monitoring network traffic and the blockage of unauthorized access. The threat detection engine 117 utilizes the SIEM systems to collect, analyze, and correlate security events from various sources to provide a comprehensive view of the security posture of the computing environments 130. The threat detection engine 117 may implement IDSs to monitor network traffic for suspicious activity and known threats by analyzing packets for deviations from expected patterns and attack signatures.

The key management module 118 may be implemented with hardware, software, or a combination thereof to manage when and/or how keys are rotated. To rotate keys, the key management module 118 may access the encryption keys 126 stored in the data repository 120. The encryption keys 118 may be used by the key management module 118 to implement encryption strategies that require the use of encryption keys. Different types of keys associated with different encryption levels may be stored in the data repository 120 for use by the key management module 118.

Additional embodiments and/or examples relating to computer networks are described below in Section 5, titled “Computer Networks and Cloud Networks.”

### 3. Flowcharts Implementing Operations for Encrypting Data for a Computing Environment(s)

FIG. 2 illustrates an example set of operations for strategically encrypting data transmitted across or stored in a computing environment. The operations may be performed, for example, by SEP 110 in the computing environment 130. One or more operations illustrated in FIG. 2 may be modified, rearranged, or omitted. Accordingly, the particular sequence of operations illustrated in FIG. 2 should not be construed as limiting the scope of one or more embodiments.

In an embodiment, the system obtains a set of data for transmission across a computing environment (Operation 202). The set of data may be obtained from any one of the components included in a computing environment. For example, if end-to-end encryption (E2EE) is being used to encrypt the set of data with AES-256, then encryption may occur at a user terminal (e.g., IoT device, mobile device, or laptop). In this example, the system may obtain the set of data from the operating system of a user terminal or, more specifically, from an application executing on the user terminal (e.g., IoT device, mobile device, or laptop). From the perspective of server-side encryption (SSE), the set of data will be obtained by the system from an application executing on the cloud server within, for example, a private cloud or the public cloud. In an embodiment, if the set of data is going to be encrypted with ChaCha20, then encryption may occur at an endpoint, for example, a server or user terminal. In this embodiment, the system may obtain the set of data from a web browser or messaging application executing on a user terminal. Additionally, the system may obtain the set of data from a VPN client on the user terminal. Likewise, the system may obtain the set of data from a server through a web browser application or from an application executing on the VPN server (e.g., WireGuard, OpenVPN, or IPSec-based daemons). In an embodiment, the set of data may be obtained from a transmission component included in any of the components of a computing environment. For example, the system may obtain the set of data from a network interface card (NIC) found on a user terminal, a gateway, a node (e.g., 130a-130d in FIG. 1A), a database, and/or server.

After obtaining the set of data, and in real time during the transmission process, a set of encryption requirements for the set of data is determined (Operation 204). The system may read metadata being transmitted with the set of data to obtain the encryption requirements associated with that data that is embedded in the metadata. In some embodiments, the system may read the set of data packet-by-packet to determine the compliance-based classification associated with each packet in real-time during the transmission process. For example, after extracting the compliance-based classification from the data, a compliance-based classification of the data can be determined. Next, the system determines the encryption requirements for the set of data based on the compliance-based classification of the set of data. In an embodiment, the compliance-based classification of data indicates a level of encryption for the data based on a regulation set forth by the originator of the data. The system determines the level of encryption for the data based on compliance-based classification, without consideration of the actual data itself. In other words, how the data is classified rather than what information is included in the data itself may be used to set the level of encryption for that data. The originator of the data, in an embodiment, is the creator of the data or the source of the data.

In some embodiments, each of the data packets includes the compliance-based classification for the data in the packet. For example, data that is classified as protected health information (PHI) and is mandated to comply with HIPAA regulations requires a strong encryption; thus, regardless of the data, its compliance-based classification (e.g., PHI) dictates that this data be encrypted with a strong encryption. In another example, the system detects, from a packet of data, that a particular compliance-based classification for that data pertains to federal data controlled by the security standards of FedRAMP. The compliance-based classification indicates the impact level of the data. For example, the impact level of the data may be low for data that is public or non-sensitive data, may be moderate for data that is controlled unclassified information, or may be high for data that is sensitive or for mission-critical systems (e.g., law enforcement or emergency response). Thus, when the system detects, from a packet of data, that a particular compliance-based classification for that data pertains to a high impact level, then the encryption strategy selected may be AES-256, ensuring a strong encryption is being used to encrypt that data. When the system detects, from a packet of data, that a particular compliance-based classification for that data pertains to a low impact level, then the encryption strategy selected may be AES-128, using a weak encryption for encrypting that data. The system can monitor, packet-by-packet, the set of data. By monitoring the compliance-based classification for each packet and adjusting the encryption level of the data for each packet, the encryption strategy can be adjusted in real time for a set of data. For example, obtaining the first packet with a first compliance-based classification, indicating a weak encryption level, is what is needed for the level of encryption. Then obtaining a second packet with a second compliance-based classification, indicating a strong encryption level is required for the level of encryption. As such, the system will adjust the encryption levels for each packet as they are transmitted. Thus, the encryption requirements are adjusted for the set of data in real time. Additionally, each packet of data within a dataset may use different encryption keys based on the encryption requirement for that packet of data to adjust the encryption requirements for the set of data in real time. For example, if the first packet of data has a compliance-based classification pertaining to a low impact level, then a 128-bit key for AES-128 may be used for symmetric encryption, and if the second packet of data, following the first packet of data, has a compliance-based classification pertaining to a high impact level, then a 256-bit key for AES-256 may be used for symmetric encryption.

After obtaining the set of data, the system determines the characteristics of a computing environment in which the set of data is to be transmitted. The system may select an encryption strategy based on an assessment of the characteristics of the computing environment. Characteristics of the computing environment for the data path traveled may be, for example, but are not limited to, the resources that the set of data is traversing during the transmission. For example, referring to FIG. 1A, the system may detect the computing environment 130 and the path starting at user terminal 130h, to gateway 130g, to node 130a, to node 130c, to node 130d, and to database 130e, that the data is transmitted through. Also, characteristics corresponding to the computing environment may include, but are not limited to, the software employed within the environment, connections and networks within the environment, security measures within the environment, user access and roles of the environment, how data is managed, the compliance and governance of the environment, how resources are shared, and the types of computing environments, etc. The system may detect that the set of data is to be transmitted across a private cloud. Because the set of data is to be transmitted through a private cloud, the encryption requirements for that data may be weaker than if, for example, the system determines that the set of data is to be transmitted across a public cloud to reach its destination.

When determining the set of encryption requirements in real time, the system may identify one or more networks, included in the computing environment, that are to be traversed by the set of data during the transmission of the set of data. Characteristics corresponding to any of the networks may include, but are not limited to, the resources the set of data may traverse during the transmission. Referring to the example computing environment 130 of FIG. 1A, the first network may be a first group of devices, including devices 130a, 130c, 130d, 130e, 130g, and 130h, and the second network may be a second group of devices, including devices 130b, 130c, 130d, 130e, 130g, and 130i. Since the first set of data is to traverse the first group of devices having a first set of characteristics and the second group of devices having the second set of characteristics that are different than the first set of characteristics, the system may determine the set of encryption requirements based on the characteristics associated with both the first and second groups of devices to be traveled by the data. In an embodiment, the characteristics associated with both the first and second groups may also include connections and networks within the groups, security measures within the groups, user access and roles of the groups, how data is managed within each group, the compliance and governance of the groups, how resources are shared within the groups, and the types of devices within the groups, etc. For example, because the first set of data is to traverse the first group of devices associated with a private cloud and having a first set of characteristics and a second group of devices associated with a public cloud having a second set of characteristics, the system may determine the first set of encryption requirements based on the characteristics associated with both the private and public clouds, including the first and second groups of devices, respectively, to be traveled by the data.

In another example, if the set of data is required to be transmitted through both a public and private cloud to reach its destination, then the encryption requirements for that data require a strong encryption because of the uncertainty of the public cloud regardless of how secure the private cloud may be. Thus, different encryption requirements are determined for the data based on the different characteristics of the computing environment. In an embodiment, after the system detects the characteristics of a transport layer of the Open Systems Interconnection (OSI) model, the system determines the set of encryption requirements for the set of data based on the detected characteristics. For example, characteristics of the OSI model may include flow rate control, segmentation and reassembly services, error detection and correction, multiplexing and demultiplexing, etc. For example, the flow rate control may indicate there is backpressure in layer 2 of a network by a switch (e.g., inside a gateway, Wi-Fi router, or node) that is signaling an upstream device to slow down or stop sending data when its buffer is getting full. The system may detect these changing characteristics and adjust the encryption requirements in real time based on the changing characteristics. If the first packet of data is affected by the backpressure, then the next or second packet of data transmitted may be encrypted with a stronger encryption (e.g., AES-256) than the first packet (e.g., AES-128) due to the slowing down of data within the traveled data path.

When determining the set of encryption requirements in real time, the system may perform real-time monitoring of the computing environment to be traversed using AI to detect an AI attack or an anomaly occurring in the computing environment. In an example, system performs, in real time during the transmission process, monitoring of the computing environment. The AI monitoring may result in detecting various types of attacks including, but not limited to, an AI-based attack on the computing environment. An AI-based attack can leverage machine learning, deep learning, or intelligent automation to learn, evolve, and optimize malicious behavior within a computing network. Some examples of AI-based attacks may include, but are not limited to, phishing, malware, network intrusion, distributed denial of service (DDoS), data exfiltration, password cracking, and botnets. When using AI to monitor for attacks on the computing environment, machine learning using intelligent pattern recognition may be used to detect unusual or suspicious activity. AI systems may analyze network traffic, system logs, user behavior, and connected devices to identify threats or anomalies in real time, including new or evolving attacks. AI techniques used for monitoring include, but are not limited to, machine learning, anomaly detection, behavioral analysis, natural language processing, threat intelligence integration, and automate response systems. AI may monitor network traffic patterns, user behavior, endpoint activity, system logs, and external communications. Examples of threats that AI can detect include, but are not limited to, DDoS attacks, Malware or ransomware, phishing, data exfiltration, insider threats, and MITM attacks. If, for example, an MITM attack is detected by the system using AI to monitor the computing environment, then the encryption strength used to encrypt the set of data may be increased. In contrast, if no MITM attack was detected by the AI monitoring, then a weaker encryption strength may be used.

The system may also determine the set of encryption requirements based on the characteristics of the AI attack. For example, the system is used to determine the set of encryption requirements based on the characteristics of the AI attack. If, for example, the system detects a man-in-the-middle (MITM) attack, then, based on the characteristics of this type of AI attack, the set of encryption requirements for the data may include quantum-resistant algorithms or post-quantum cryptography. The quantum-resistant algorithm types may include, for example, lattice-based, code-based, multivariate, hash-based, and isogeny-based ciphers. If, for example, the threat detection engine 117 detects a DDoS attack, then based on the characteristics of this type of AI attack, the set of encryption requirements for the data may include TLS or AES to mitigate the attack by protecting the data with these encryption schemes.

When determining the set of encryption requirements based on the characteristics of the AI attack, the system may select a quantum-attack resistant encryption layer for encrypting the set of data to generate the encrypted set of data. For example, for the set of encryption requirements based on the characteristics of the AI attack (e.g., MITM attack), the system may select a quantum-attack resistant encryption layer. The system may then encrypt the set of data with a quantum-resistant algorithm type to generate the encrypted set of data. In an embodiment, the quantum-resistant encryption layer includes at least one of a lattice-based cryptographic scheme or a hash-based cryptographic scheme.

In an embodiment, the system may determine encryption requirements based on the data itself or data type apart from what the compliance-based classification is for that data packet. Thus, by reading the content of the actual data itself, the system may determine the encryption requirements for that data packet. For example, when the system determines that the sensitivity level of the data itself or data type is high, having, for example, a law enforcement, an emergency system, or a healthcare data type, then the encryption strategy for the data may require a strong encryption level. Put another way, the data type may be used to set the level of encryption used for the corresponding data or type of encryption used for the corresponding data. For example, when the data type includes protected health information (PHI), then the corresponding data is mandated to comply with HIPAA regulations and thus may require the use of a strong encryption. Here again, for determining the encryption requirements for each packet of data, the data itself or data type in each packet of data may be used by the system to determine the encryption requirements for each packet of data. In this way, encryption requirements can be determined in real time, packet-by-packet, for a given transmission process.

Based on the set of encryption requirements for the set of data, the system selects in real time, an encryption strategy from a set of encryption strategies for encrypting the set of data (Operation 206). For example, during the time that the data is received during the process of transmission, the system selects from a set of encryption strategies, a specific encryption strategy to encrypt the set of data. The system may select from the stored encryption strategies located in a data repository. The system may select the encryption strategy based on the encryption requirements for the set of data. For example, the system may execute a query against a table, such as a look-up table, that maps encryption requirements to encryption strategies. In another example, the system may determine a subset of encryption strategies that meet the encryption requirements. Then, the system may select the most efficient or least computationally expensive encryption strategy from the subset of encryption strategies to apply to the set of data. For example, if the encryption requirement for the data is to mitigate or prevent against man-in-the-middle (MITM) attacks, then the system may select a quantum-attack resistant encryption strategy after using a table to map this encryption requirement to the encryption strategy. In another example, the system may determine a subset of encryption strategies that include learning with errors (LWE), ring-LWE, Kyber, FrodoKEM, and Module-LWE that meet the encryption requirements for an MITM attack and are quantum-safe. If Kyber is considered the least computationally expensive among the subset, then the system may select the least computationally expensive encryption strategy (i.e., Kyber) from the subset of encryption strategies to apply to the set of data.

Based on the set of encryption requirements for the set of data, the system encrypts the set of data using the selected encryption strategy to generate an encrypted set of data (Operation 208). For example, the system may encrypt the set of data using Kyber when the encryption strategy is selected based on the least computationally expensive encryption strategy to prevent or mitigate against MITM attacks. In an embodiment, the system may encrypt a first packet of data with a first encryption strategy and a subsequent second packet of data with a second encryption strategy, adjusting the encryption of the set of data in real time. For example, the system may encrypt the first packet of data with Kyber, then, to implement a stronger but more computationally expensive encryption, encrypt the second packet of data with LWE to make the set of data more quantum-safe against MITM attacks by adjusting encryption in real time. The system may encrypt the set of data using encryption keys 126 stored in the data repository in accordance with the first encryption strategy to generate the encrypted first set of data.

In an embodiment, the system transmits the encrypted set of data across the computing environment (Operation 210). A transmission component of the system transmits the encrypted set of data across the computing environment. Referring to the example computing environment 130 of FIG. 1A, the set of components include the user terminal 130h, gateway 130g, node 130a, node 130c, node 130d, and database 130e. The transmission component 115 may interact with a network interface card (NIC) to convert the encrypted data from the CPU into signal (e.g., electrical, optical, or radio) for transmission across the computing environment 130 or network. The first packet data, encrypted using Kyber, may be converted into a signal and transmitted across the computing environment 130. Next, the second packet of data, encrypted using LWE, may be converted into a signal and transmitted across the computing environment 130 to implement real-time encryption during the transmission process.

After transmitting the encrypted set of data, the system may detect an anomaly or attack in the computing environment or may detect that a threshold amount of time has passed since using a current encryption key (Operation 212). For example, the system may detect an anomaly or an attack associated with the computing environment transporting the encrypted first set of data. The system may detect the anomaly or the attack before or during the transmission process. For example, the system may detect the anomaly or the attack during or after transmission of the set of data. In an embodiment, the system may use AI to detect an anomaly or an attack in the computing environment across which the encrypted first of data is being transported.

Responsive to detecting a security event, (e.g., an anomaly or an attack), the system may rotate a set of one or more encryption keys used by the transmission process to select a new set of one or more encryption keys (Operation 214). A second set of data may be encrypted using the new set of one or more encryption keys. For example, if an anomaly or an attack is detected, then system may encrypt additional data with a new set of one or more encryption keys. When, for example, a first set of data is encrypted with one or more encryption keys then transmitted across the computing environment, an attack on the computing environment may be detected. Thus, before the next or second set of data is transmitted across the computing environment, a new set of one or more encryption keys is selected. The new set of encryption keys is different from the encryption keys used to send the first set of data. The new set of encryption keys is used to encrypt the second set of data. Thus, the system can adjust the encryption keys in real time during the transmission process in response to a detected attack or anomaly.

In one example, encryption may be modified mid-transmission. A first set of data is encrypted with a first set of one or more encryption keys and transmitted across the computing environment. Before the first set of data reaches a final destination, the system detects an attack or anomaly within the computing environment. In response to detection of the anomaly, an intermediate device, on a communication path for the first set of data, decrypts the first set of data. Furthermore, the intermediate re-encrypts the first set of data using a new set of one or more encryption keys to obtain re-encrypted data. The intermediate device then transmits the re-encrypted data toward the original destination or a new destination. Accordingly, the system can adjust the encryption keys in real time during the transmission process in response to a detected attack or anomaly.

In an embodiment, the system may perform a key rotation based on a key usage threshold. For example, system may detect that encrypting the first set of data results in meeting a threshold volume of data that has been encrypted using the first set of one or more encryption keys. Responsive to this, if the system then detects that the threshold volume of data has been met, then a set of one or more encryption keys used by the transmission process is rotated to select a new set of one or more encryption keys. The system uses hardware and software for tracking how much data has been encrypted with the current keys. For example, the system may interact with a cryptographic accelerator, crypto engine, network processing unit, secure elements or TPMS of routers, firewalls, VPNs, etc., to obtain statistics related to key usage (e.g., key usage threshold). The system may interact with cryptographic stacks, security protocols implemented in the operating systems, and/or firmware of routers, firewalls, VPNs, etc., to obtain statistics related to key usage (e.g., key usage threshold). After detecting that a key usage threshold is met, a subsequently transmitted set of data may be encrypted using a new set of one or more encryption keys. For example, after detecting that a threshold amount of data (e.g., 68.7 GB) has been encrypted with a current set of encryption keys, a new and different set of encryption keys may be used to encrypt a second set of data.

In an embodiment, the system may perform a key rotation that is a time-based rotation. For example, the system may detect that encrypting the first set of data results in meeting a threshold time interval for encrypting data using the first set of one or more encryption keys. Responsive to this, if the system then detects that the threshold time interval for encrypting the data has been met, then a set of one or more encryption keys used by the transmission process is rotated to select a new set of one or more encryption keys. For example, the system uses hardware and software for tracking how much time has passed using the current keys. For example, the system may interact with a hardware security module (HSM), real-time clock (RTC), timer module, trusted platform module (TPM), and/or network processing unit (NPU) of routers, firewalls, VPNs, etc., to obtain statistics related to key usage (e.g., threshold time interval and/or time trigger). For example, the system may interact with the network device's operating systems, key management software, network operating systems, and/or security protocols implemented in the operating systems or firmware of routers, firewalls, VPNs, etc., to obtain statistics related to key usage (e.g., threshold time interval and/or time trigger). After detecting that a key usage time has elapsed, the second set of data may be encrypted using the new set of one or more encryption keys. For example, after encrypting, with a first set of encryption keys, for a threshold time interval for a first set of data or more (e.g., every 90 days), a new and different set of encryption keys may be used to encrypt a second set of data. However, if an anomaly or attack in the computing environment is not detected or the threshold time or threshold has not passed since using the current encryption key, then the system may obtain a second set of data for transmission across a computing environment 130 and repeat operations 204 to 210 using the previously used encryptions keys.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

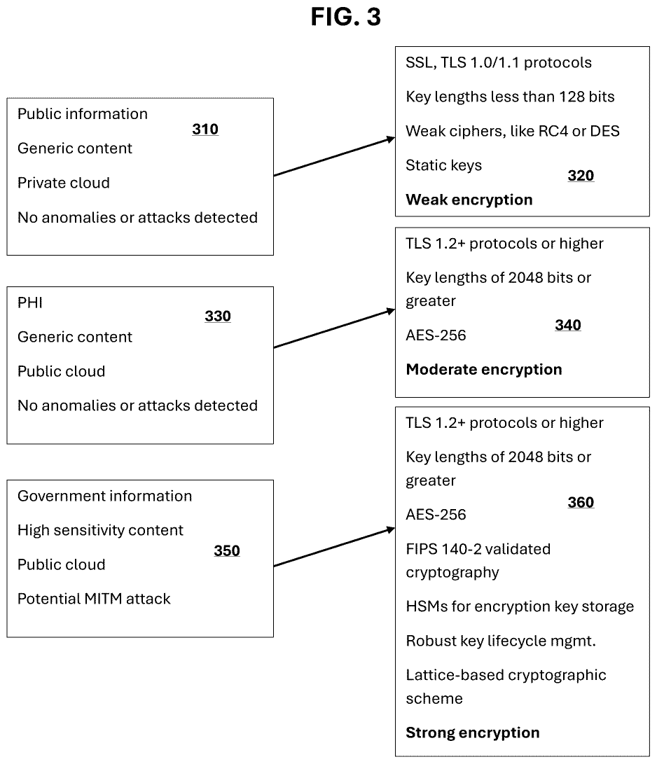

As illustrated in FIG. 3, a system 100 determines a mapping between different encryption requirements and the different encryption strategies. The data preprocessing engine 111 may use the encryption requirements detector 112 to read the data to obtain the encryption requirements associated with that data. In an embodiment, the compliance-based classification is extracted from a packet of data that indicates a level of encryption for the data based on a regulation set forth by the originator of the data. In an embodiment, after determining the compliance-based classification from the data, the first encryption strategy may be selected by the encryption strategy selector 113, taking into account the compliance-based classification of the data and other factors (e.g., the sensitivity level of the data itself, the characteristics of the computing environment, anomalies or attacks known or possible in the computing environment, and the deployment environment). The environment detection module 116 may determine a set of characteristics corresponding to the computing environment that is to be traveled by the first set of data. Characteristics of the computing environment for the data path traveled may be, for example, but are not limited to, the resources that the first set of data may traverse during the transmission. The threat detection engine 117 may detect an anomaly or an attack associated with the computing environment 130, transporting the encrypted first set of data before or during the transmission process.

Thus, each box on the left (i.e., the left column) of FIG. 3 provides, from top to bottom, a compliance-based classification, sensitivity level of the data itself, computing environment resources the data is to traverse, and if there is a detected anomaly or attack on the computing environment transporting or that will be transporting the data. Each box on the right (i.e., the right column) of FIG. 3 provides the selected encryption strategy for the data.

For example, referring to box 310, the compliance-based classification for the data is public information. The sensitivity level of the data itself is generic content, including product descriptions. Also, the computing environment resources the data is to traverse is a private cloud, and there are no detected anomalies or attacks on the computing environment. Then, the encryption strategy for the data, referring to box 320, may require a weak encryption strategy, implementing outdated protocols SSL, TLS, 1.0/1.1, short key lengths that are 128 bits or less, weak ciphers, such as RC4 or DES, and static keys that are never rotated or updated.

Referring to box 330, for example, the compliance-based classification for the data is protected health information (PHI) as required by HIPAA. The sensitivity level of the data itself is generic content, including non-private information as indicated by HIPAA. Also, the computing environment resources the data is to traverse is a public cloud, and there are no detected anomalies or attacks on the computing environment. Then, the encryption strategy for the data, referring to box 340, may require a ‘moderate encryption’ strategy (i.e., a higher-level encryption than the weak encryption for box 320), implementing TLS 1.2 or greater in-transit encryption, key lengths of 2048 bits or greater, and at rest encryption of (advanced encryption standard) AES-256.

Referring to box 350, for example, the compliance-based classification for the data is government or military data as indicated by FedRAMP. The sensitivity level of the data itself is high impact, having law enforcement, emergency systems, or healthcare data. Also, the computing environment resources the data is to traverse is a public cloud, and there are detected anomalies in the computing environment, indicating potential MITM attacks. Then, the encryption strategy for the data, referring to box 360, may require a ‘strong encryption’ strategy (i.e., a higher-level encryption than the moderate encryption for box 340), implementing TLS 1.2 or greater in-transit encryption, key lengths of 2048 bits or greater, and at rest encryption of (advanced encryption standard) AES-256 as well as Federal Information Processing Standard Publication 140-2 (FIPS 140-2) validated cryptography, hardware security modules (HSMs) for encryption key storage, and robust key lifecycle management (mgmt.). Also, because of the potential MITM attack, the encryption strategy for box 360 may also include implementing a quantum-attack resistant encryption layer that includes at least one of a lattice-based cryptographic scheme or a hash-based cryptographic scheme for encrypting the data.

### 5. Computer Networks and Cloud Networks

In one or more embodiments, an environment provisioning platform may be implemented in a computer network that provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally, or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including, but not limited to, Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including, but not limited to, a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network includes a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, multiple tenants may share the database.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

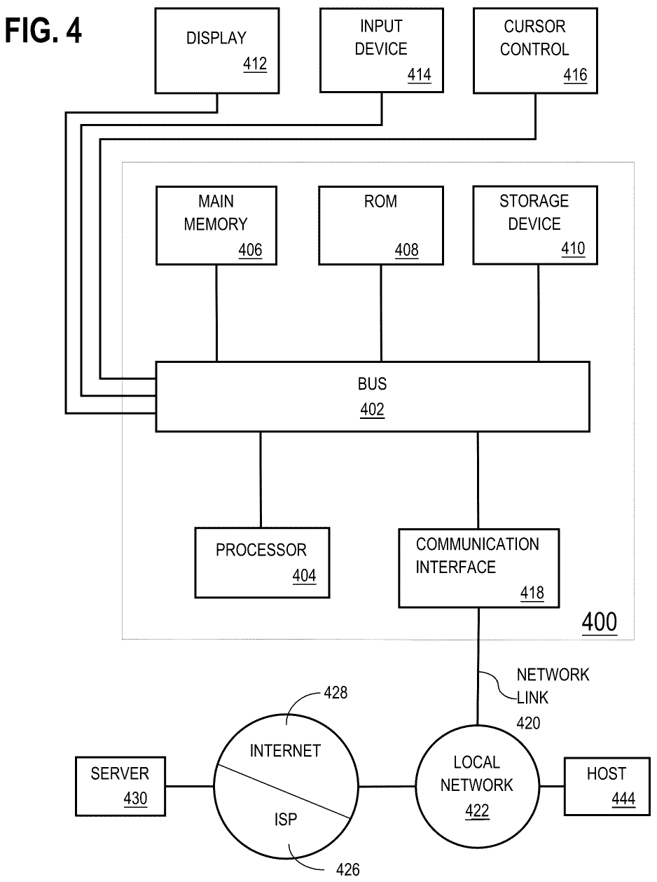

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may include non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426, in turn, provides data communication services through the worldwide packet data communication network now commonly referred to as the “Internet” 428. Local network 422 and Internet 428 both use electrical, electromagnetic, or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the disclosure have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

In an embodiment, a computer system, such as computer system 400, includes one or more hardware processors (e.g., 404). The computer system also includes one or more non-transitory computer-readable media (e.g., main memory 406, ROM 408, or storage device 410) storing instructions that, when executed by the one or more hardware processors, cause the system to perform operations. These operations include obtaining a first set of data for transmission across a computing environment using a transmission process, the computing environment including a first set of computing resources, and subsequent to obtaining the first set of data and in real-time during the transmission process, determining a first set of encryption requirements for the first set of data. These operations further include based on the first set of encryption requirements for the first set of data: selecting a first encryption strategy, from a plurality of encryption strategies, in real-time for encrypting the first set of data; encrypting the first set of data using the first encryption strategy to generate an encrypted first set of data; and transmitting the encrypted first set of data across the computing environment. These operations also include obtaining a second set of data for transmission across the computing environment using the transmission process, and subsequent to obtaining the second set of data and in real-time during the transmission process, determining a second set of encryption requirements for the second set of data. These operations further include based on the second set of encryption requirements for the second set of data: selecting a second encryption strategy, from the plurality of encryption strategies, for encrypting the second set of data, wherein the second encryption strategy is different than the first encryption strategy; encrypting the second set of data using second first encryption strategy to generate an encrypted second set of data; and transmitting the encrypted second set of data across the computing environment.

### 7. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium includes instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause performance of operations comprising:
obtaining a first set of data for transmission across a computing environment using a transmission process, the computing environment comprising a first set of computing resources;
subsequent to obtaining the first set of data and in real-time during the transmission process, determining a first set of encryption requirements for the first set of data;
based on the first set of encryption requirements for the first set of data:
selecting a first encryption strategy, from a plurality of encryption strategies, in real-time for encrypting the first set of data;
encrypting the first set of data using the first encryption strategy to generate an encrypted first set of data; and
transmitting the encrypted first set of data across the computing environment;
obtaining a second set of data for transmission across the computing environment using the transmission process;
subsequent to obtaining the second set of data and in real-time during the transmission process, determining a second set of encryption requirements for the second set of data; and
based on the second set of encryption requirements for the second set of data:
selecting a second encryption strategy, from the plurality of encryption strategies, for encrypting the second set of data, wherein the second encryption strategy is different than the first encryption strategy;
encrypting the second set of data using the second encryption strategy to generate an encrypted second set of data; and
transmitting the encrypted second set of data across the computing environment.

2. The one or more non-transitory computer readable media of claim 1, wherein selecting the first encryption strategy based on the first set of encryption requirements comprises:
determining a compliance-based classification from the first set of encryption requirements; and
selecting the first encryption strategy based on the compliance-based classification.

3. The one or more non-transitory computer readable media of claim 1, wherein determining the first set of encryption requirements in real-time comprises:
determining a set of characteristics corresponding to the computing environment that is to be traversed by the first set of data during the transmission of the first set of data; and
determining the first set of encryption requirements based on the set of characteristics corresponding to the computing environment.

4. The one or more non-transitory computer readable media of claim 3, wherein determining a set of characteristics corresponding to the computing environment comprises:
performing real-time monitoring of the computing environment for bandwidth availability.

5. The one or more non-transitory computer readable media of claim 3, wherein determining a set of characteristics corresponding to the computing environment comprises:
performing real-time monitoring of the computing environment for latency.

6. The one or more non-transitory computer readable media of claim 3, wherein determining a set of characteristics corresponding to the computing environment comprises:
performing real-time monitoring of the computing environment for a deviation in a transmission path across the computing environment.

7. The one or more non-transitory computer readable media of claim 3, wherein determining a set of characteristics corresponding to the computing environment comprises:
performing real-time monitoring of the computing environment for potential attack vectors.

8. The one or more non-transitory computer readable media of claim 1, wherein determining the first set of encryption requirements in real-time comprises:
identifying a first network and a second network comprised in the computing environment that are to be traversed by the first set of data during the transmission of the first set of data;
determining a first set of characteristics corresponding to the first network and a second set of characteristics corresponding to the second network; and
determining the first set of encryption requirements based on the first set of characteristics and the second set of characteristics.

9. The one or more non-transitory computer readable media of claim 8, wherein:
the first network comprises a private cloud-based computing environment; and
the second network comprises a public cloud-based computing environment.

10. The one or more non-transitory computer readable media of claim 1, wherein determining the first set of encryption requirements in real-time comprises:
performing real-time monitoring of the computing environment using artificial intelligence (AI) to detect an AI attack occurring in the computing environment; and
determining the first set of encryption requirements based on the characteristics of the AI attack.

11. The one or more non-transitory computer readable media of claim 10, wherein determining the first set of encryption requirements based on the characteristics of the AI attack comprises:
selecting a quantum-attack resistant encryption layer for encrypting the first set of data to generate the encrypted first set of data.

12. The one or more non-transitory computer readable media of claim 11, wherein the quantum-resistant encryption layer comprises at least one of a lattice-based cryptographic scheme or a hash-based cryptographic scheme.

13. The one or more non-transitory computer readable media of claim 1, wherein the operations further comprise:
detecting an anomaly or an attack associated with the computing environment transporting the encrypted first set of data; and
responsive to detecting the anomaly or the attack, rotating a set of one or more encryption keys used by the transmission process to select a new set of one or more encryption keys;
wherein the second set of data was encrypted using the new set of one or more encryption keys.

14. The one or more non-transitory computer readable media of claim 1, wherein the first of data is encrypted using a first set of one or more encryption keys and wherein the operations further comprise:
detecting that encrypting the first set of data results in meeting a threshold volume of data that has been encrypted using the first set of one or more encryption keys; and
responsive to detecting that the threshold volume of data has been met, rotating a set of one or more encryption keys used by the transmission process to select a new set of one or more encryption keys;
wherein the second set of data was encrypted using the new set of one or more encryption keys.

15. The one or more non-transitory computer readable media of claim 1, wherein the first of data is encrypted using a first set of one or more encryption keys and wherein the operations further comprise:
detecting that encrypting the first set of data results in meeting a threshold time interval for encrypting data using the first set of one or more encryption keys; and
responsive to detecting that the threshold time interval has been met, rotating a set of one or more encryption keys used by the transmission process to select a new set of one or more encryption keys;
wherein the second set of data was encrypted using the new set of one or more encryption keys.

16. The one or more non-transitory computer readable media of claim 1, wherein the operations further comprise:
detecting an anomaly or an attack associated with the computing environment transporting the encrypted first set of data; and
responsive to detecting the anomaly or the attack:
decrypting, by an intermediate node within the computing environment, the encrypted first set of data to obtain the first set of data;
re-encrypting the first set of data using a new encryption key to generate a re-encrypted first set of data; and
forwarding, by the intermediate node within the computing environment and toward a destination, the re-encrypted first set of data.

17. The one or more non-transitory computer readable media of claim 1, wherein the first set of
encryption requirements are determined based on the transport layer of the Open Systems Interconnection (OSI) model.

18. The one or more non-transitory computer readable media of claim 1, wherein determining the first set of encryption requirements for the first set of data comprises:
determining a data type of the first set of data; and
determining the first set of encryption requirements based on the data type of the first set of data.

19. A method comprising:
obtaining a first set of data for transmission across a computing environment using a transmission process, the computing environment comprising a first set of computing resources;
subsequent to obtaining the first set of data and in real-time during the transmission process, determining a first set of encryption requirements for the first set of data;
based on the first set of encryption requirements for the first set of data:
selecting a first encryption strategy, from a plurality of encryption strategies, in real-time for encrypting the first set of data;
encrypting the first set of data using the first encryption strategy to generate an encrypted first set of data; and
transmitting the encrypted first set of data across the computing environment;
obtaining a second set of data for transmission across the computing environment using the transmission process;
subsequent to obtaining the second set of data and in real-time during the transmission process, determining a second set of encryption requirements for the second set of data; and
based on the second set of encryption requirements for the second set of data:
selecting a second encryption strategy, from the plurality of encryption strategies, for encrypting the second set of data, wherein the second encryption strategy is different than the first encryption strategy;
encrypting the second set of data using second first encryption strategy to generate an encrypted second set of data; and
transmitting the encrypted second set of data across the computing environment.

20. A system comprising:
one or more processors;
one or more non-transitory computer-readable media; and
program instructions stored on the one or more non-transitory computer-readable media that, when executed by the one or more hardware processors, cause the system to perform operations comprising:
obtaining a first set of data for transmission across a computing environment using a transmission process, the computing environment comprising a first set of computing resources;
subsequent to obtaining the first set of data and in real-time during the transmission process, determining a first set of encryption requirements for the first set of data;
based on the first set of encryption requirements for the first set of data:
selecting a first encryption strategy, from a plurality of encryption strategies, in real-time for encrypting the first set of data;
encrypting the first set of data using the first encryption strategy to generate an encrypted first set of data; and
transmitting the encrypted first set of data across the computing environment;
obtaining a second set of data for transmission across the computing environment using the transmission process;
subsequent to obtaining the second set of data and in real-time during the transmission process, determining a second set of encryption requirements for the second set of data; and
based on the second set of encryption requirements for the second set of data:
selecting a second encryption strategy, from the plurality of encryption strategies, for encrypting the second set of data, wherein the second encryption strategy is different than the first encryption strategy;
encrypting the second set of data using second first encryption strategy to generate an encrypted second set of data; and
transmitting the encrypted second set of data across the computing environment.
